(19) United States
(12) Patent Application Publication
(10) Pub. No.: US 2008/0213628 A1
(43) Pub. Date: Sep. 4, 2008

(54) Perpendicular recording media with Ta transition layer to improve magnetic and corrosion resistance performances and method of manufacturing the same

(75) Inventors: Abebe Hailu, San Jose, CA (US); Raj Thangaraj, Fremont, CA (US); Miaogen Lu, Fremont, CA (US); Qixu Chen, Milpitas, CA (US); Michael Z. Wu, San Jose, CA (US); Mariana R. Munteanu, Santa Clara, CA (US); Kuo-Hsing Hwang, San Jose, CA (US)

Correspondence Address: Seagate Technology;c/o DARBY & DARBY P.C., P.O. Box 770, Church Street Station, New York, NY, 10008-0770, US

(73) Assignee: SEAGATE TECHNOLOGY LLC, Scotts Valley, CA (US)

(21) Appl. No.: 11/712,560

(22) Filed: Mar. 1, 2007

(51) Int. Cl. G11B 5/66; B05D 5/12

(52) U.S. Cl. 428/828; 427/128

(57) ABSTRACT

A perpendicular magnetic recording medium comprising a substrate, an underlayer, a Ta-containing seedlayer, a magnetic layer, wherein the underlayer comprises a soft magnetic material and the Ta-containing seedlayer is between the underlayer and the magnetic layer, and a process for improving corrosion resistance of the recording medium and for manufacturing the recording medium are disclosed.

### RELATED APPLICATION

This application is related to U.S. Ser. No. 11/068,898, entitled “Perpendicular Media With Cr-Doped Fe-Alloy-Containing Soft Underlayer (SUL) For Improved Corrosion Performance,” filed on Mar. 2, 2005, which is incorporated herein by reference.

### FIELD OF INVENTION

This invention relates to perpendicular recording media, such as thin film magnetic recording disks having perpendicular recording, and to a method of manufacturing the media. More specifically, the invention relates to perpendicular recording media having a tantalum Ta transition layer to improve magnetic and corrosion resistance performances, and to a method of manufacturing the same.

### BACKGROUND

Perpendicular recording media are being developed for higher density recording as compared to longitudinal media. In a perpendicular recording media, magnetization is formed in a direction perpendicular to the surface of a magnetic medium, typically a magnetic recording layer on a suitable substrate, resulting from perpendicular anisotropy in the magnetic recording layer.

Referring to FIG. 1a, perpendicular magnetic recording media typically comprise a substrate that is made of an aluminum alloy or a glass or glass-ceramic substrate. On the substrate, sputtered layers can include a seedlayer 11, an adhesion layer (not shown in FIG. 1a) and one or more soft underlayers (SULs) 12 that can be magnetic. On top of the SUL 12 are one or more intermediate layers 13 and 14, or interlayers, and then one or more magnetic layers 15 and one or more protective layers 16. Between the SUL and the interlayers, a transition layer of Cu or Ag can be used for reasonable bit error rate (BER) and media signal to noise ratio (SNR) performances, but lacks corrosion resistance. A transition layer situated between the SUL and interlayer(s) promotes necessary crystal phase transformation from the amorphous SUL to the hexagonal close-packed (HCP) interlayer structure. The protective layer is typically a carbon overcoat which protects the magnetic layer from corrosion and oxidation and also reduces frictional forces between the disc and a read/write head. In addition, a thin layer of lubricant may be applied to the surface of the protective layer to enhance the tribological performance of the head-disc interface by reducing friction and wear of the protective overcoat.

A perpendicular recording disk medium as incorporated in a disk drive is shown in FIG. 1b. The perpendicular recording disk medium has soft magnetic underlayer 31. The magnetic layer 32 of the perpendicular recording disk medium comprises domains oriented in a direction perpendicular to the plane of the substrate 30. Also, FIG. 1b shows the following: (a) a read-write head 33 located on the recording medium, (b) traveling direction 34 of head 33 and (c) transverse direction 35 with respect to the traveling direction 34.

Currently, perpendicular recording media are processed using O₂ reactive sputtering technique, using oxide dispersants to achieve smaller and physically isolated grains, and using a thick amorphous magnetic SULs such as Fe, Ni, or Co-based alloy films. SULs and substrates based on iron and aluminum alloys are prone to corrosion. Because these metal layers can be hard to cover at disk edges (chamfer area) and at mechanical defects (voids, pits, etc.), harsh environmental conditions (HCl and water vapors at ambient and elevated temperatures) make the edges and other mechanical defects at the data zone area susceptible to corrosion. This produces edge corrosion at the edges and defect corrosion at voids and other mechanical defects. Other non-corroded layers relieve stress and bubble up in the corroded area due to hydrogen evolution during the corrosion process, and can collapse when excessive pressure builds up. This results in a unique morphology of corroded area at the chamfer area, particularly when very thin metal seed layers such as Ag and Cu develop edge corrosion defects in the absence of other major corroding layers when exposed to HCl vapors.

Accordingly, there exists a need for perpendicular magnetic recording media having adequate resistance to environmental attacks, such as corrosion, without compromising BER/SNR performances.

### SUMMARY OF THE INVENTION

An embodiment of the invention relates to a perpendicular magnetic recording medium comprising a substrate, an underlayer, a Ta-containing seedlayer, a magnetic layer, wherein the underlayer comprises a soft magnetic material and the Ta-containing seedlayer is between the underlayer and the magnetic layer. Preferably, the underlayer comprises Cr. Preferably, the underlayer comprises about 8 to 18 at % Cr. Preferably, the soft magnetic material is substantially amorphous. Preferably, the magnetic layer comprises an oxide-containing magnetic layer. The recording medium could further comprise an interlayer between the Ta-containing seedlayer and the magnetic layer. Preferably, the recording medium has substantially no edge corrosion after exposure to 0.5 N HCl vapor environment for 24 hours. Preferably, the Ta-containing seedlayer has a thickness of about 12 to 40 Å. Preferably, the Ta-containing seedlayer contains Ta in the range of 20 to 100 atomic percent. Preferably, the interlayer comprises a Ru-containing material.

Another embodiment relates to a method of improving corrosion resistance of a magnetic recording medium comprising forming an underlayer on a substrate, forming a Ta-containing seedlayer on the underlayer and depositing a magnetic perpendicular recording layer on the Ta-containing seedlayer. Preferably, the magnetic perpendicular recording medium has substantially no edge corrosion or void corrosion in the data zone area after 24-hr vapor exposure above 0.5N HCl solution in an enclosed container or after 4-day exposure at 80° C.-80% RH in a controlled humidity chamber. Preferably, the underlayer comprises a Fe-alloy. Preferably, the Fe-alloy is selected from the group consisting of a FeCoB alloy, a CoFeZr alloy, a CoFeTa alloy, and a FeCoZrB alloy. Preferably, the underlayer comprises about 9-17 at % Cr.

Yet another embodiment relates to a method of manufacturing a magnetic recording medium, comprising depositing an underlayer on a substrate, depositing a Ta-containing seedlayer on the underlayer and depositing a magnetic perpendicular recording layer on the Ta-containing seedlayer. Preferably, the underlayer comprises a Fe-alloy. Preferably, the Ta-containing seedlayer comprises Ta in the range of 20 to 100 atomic percent and the thickness of the Ta-containing seedlayer is in the range of 12 to 40 Å. Preferably, the underlayer has a polarization resistance of at least 1×10⁵ ohm-cm². Preferably, the polarization resistance is at least 1×10⁶ ohm-cm².

As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1a is a schematic of an embodiment of a perpendicular recording medium; FIG. 1b is a schematic of a perpendicular recording disk medium as incorporated in a disk drive; FIG. 1c is an embodiment of this invention.

FIG. 2a-2c are micrographs showing the top views by SEM/EDX of magnetic media having Ag seedlayer, Cu seedlayer and Ta seedlayer, respectively, on a Cr-containing soft underlayer after the magnetic media were exposed to 0.5N HCl vapor for 24 hours at room temperature in an enclosed chamber.

### DETAILED DESCRIPTION

The invention provides a method and apparatus for magnetic recording media having improved corrosion resistance and improved magnetic performance. In order to retain or improve magnetic performance and/or maintain or improve grain size and distribution in the magnetic storage layer, the performance layer should maintain tight C-axis dispersion angle in the subsequently-deposited interlayer. The present invention contemplates accomplish this with a transition layer comprising tantalum.

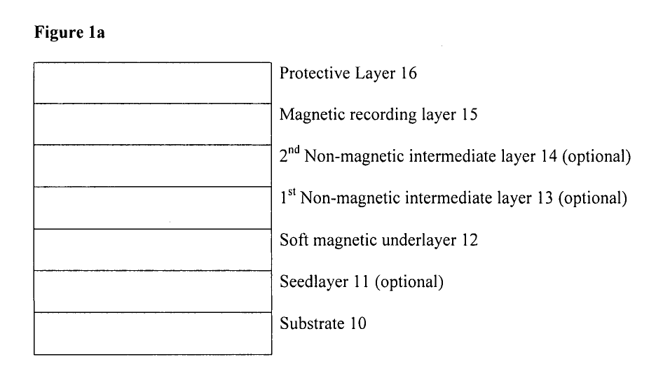

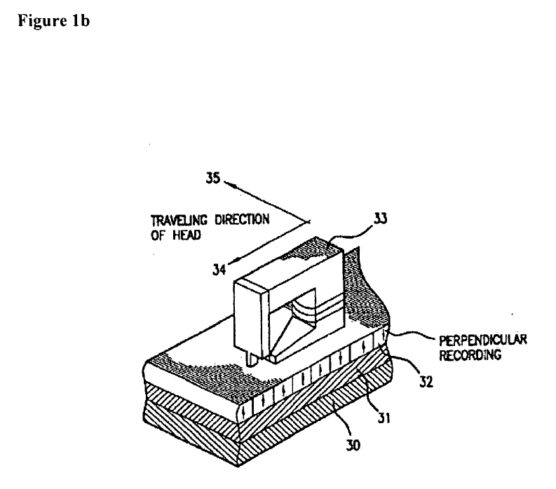

The embodiments of this invention comprise of a method and apparatus for a magnetic recording media having improved corrosion resistance as well as improved magnetic performances. However, in order to retain/improve magnetic performances, any choice of new seed layer must have the properties of maintaining tight C-axis dispersion angle in the subsequently deposited interlayer as well as to maintain/improve grain size/distribution in the magnetic storage layer(s) as shown in FIG. 1c. According to the embodiments of the invention, the above demanding triple requirements are met by using Ta as the new seed layer to replace prior art Cu or Ag seed layer.

This invention provides magnetic recording media suitable for high areal recording density exhibiting high SMNR. In the embodiments of this invention, a “soft magnetic material” is a material that is easily magnetized and demagnetized. As compared to a soft magnetic material, a “hard magnetic” material is one that neither magnetizes nor demagnetizes easily.

The underlayer is “soft” because it is made up of a soft magnetic material, which is defined above, and it is called an “underlayer” because it resides under a recording layer. In a preferred embodiment, the soft layer is amorphous. The term “amorphous” means that the material of the underlayer exhibits no predominant sharp peak in an X-ray diffraction pattern as compared to background noise. The “amorphous soft underlayer” of this invention encompasses nanocrystallites in amorphous phase or any other form of a material so long the material exhibits no predominant sharp peak in an X-ray diffraction pattern as compared to background noise.

When soft underlayers are fabricated by magnetron sputtering on disk substrates, there are several components competing to determine the net anisotropy of the underlayers: effect of magnetron field, magnetostriction of film and stress originated from substrate shape, etc. Although the effect of magnetron field is not easy to be controlled without changing the design of equipment, the effect of magnetostriction and stress is very easy to be controlled by changing the sputtering conditions. Also, the soft magnetic under layers can be fabricated as single layers or multilayers with Ru or suitable spacer materials in between the soft under layers to enhance the signal to noise ratio (SNR) by antiferromagnetic coupling.

The soft underlayer in the embodiments of this invention could typically have intrinsic coercivity less than 1000 Am⁻¹. They are used primarily to enhance and/or channel the flux produced by an electric current. The main parameter, often used as a figure of merit for soft magnetic materials, is the relative permeability (μᵣ, where μᵣ=B/mₒH), which is a measure of how readily the material responds to the applied magnetic field. The other main parameters of interest are the coercivity, the saturation magnetisation and the electrical conductivity.

The types of applications for soft magnetic materials fall into two main categories: AC and DC. In DC applications the material is magnetised in order to perform an operation and then demagnetised at the conclusion of the operation, e.g. an electromagnet on a crane at a scrap yard will be switched on to attract the scrap steel and then switched off to drop the steel. In AC applications the material will be continuously cycled from being magnetised in one direction to the other, throughout the period of operation, e.g. a power supply transformer. A high permeability will be desirable for each type of application but the significance of the other properties varies.

For DC applications the main consideration for material selection is most likely to be the permeability. This would be the case, for example, in shielding applications where the flux must be channeled through the material. Where the material is used to generate a magnetic field or to create a force then the saturation magnetization may also be significant.

For AC applications as in the recording media the important consideration is how much energy is lost in the system as the material is cycled around its hysteresis loop. The energy loss can originate from three different sources: (1) hysteresis loss, which is related to the area contained within the hysteresis loop; (2) eddy current loss, which is related to the generation of electric currents in the magnetic material and the associated resistive losses and (3) anomalous loss, which is related to the movement of domain walls within the material. Hysteresis losses can be reduced by the reduction of the intrinsic coercivity, with a consequent reduction in the area contained within the hysteresis loop. Eddy current losses can be reduced by decreasing the electrical conductivity of the material and by laminating the material, which has an influence on overall conductivity and is important because of skin effects at higher frequency. Finally, the anomalous losses can be reduced by having a completely homogeneous material, within which there will be no hindrance to the motion of domain walls.

In the embodiments of this invention, the Ta-containing seedlayer is a layer lying in between the underlayer and the magnetic layer Proper seedlayer can also control anisotropy of the interlayer, which could be located between the seedlayer and the magnetic layer, by promoting microstructure that exhibit either short-range ordering under the influence of magnetron field or different magnetostriction. The seedlayer could also alter local stresses in the interlayer. The seedlayer could also maintain tight C-axis dispersion angle in the interlayer as well as maintain/improve grain size/distribution in the magnetic storage layer. The embodiments of this invention also provides a method and apparatus for a magnetic recording medium having improved edge corrosion resistance of the medium.

Edge corrosion is the corrosion-induced defect in perpendicular media at the outer diameter (OD), i.e., the chamfer area, when it is exposed to 0.5N HCl vapor environment for 24 hours. Perpendicular media that have metal layers are prone to corrosion and vulnerable to this type of defects. When HCl vapor attacks the edge, the metal layers, which are prone to HCl attack is eaten away by the corrosive vapors. Other non-corroded layers relieve any stress by forming bubbles in the corroded area due to hydrogen evolution during the corrosion process. These bubbles collapse when excessive pressure builds up. This results in a unique morphology of corroded area at OD edges. Especially, perpendicular media with very thin metal seed layers such as Ag and Cu develop edge corrosion defects in the absence other major corroding layers when exposed to HCl vapors.

In an embodiment, a magnetron field could produce the radial anisotropy in the soft underlayer. In a magnetron, electrons generated from a heated cathode move under the combined force of a radial electric field and an axial magnetic field. By its structure, a magnetron causes moving electrons to interact synchronously with traveling-wave components of a microwave standing-wave pattern in such a manner that electron potential energy is converted to microwave energy with high efficiency.

The magnetron is a device of essentially cylindrical symmetry. On the central axis is a hollow cylindrical cathode. The outer surface of the cathode carries electron-emitting materials, primarily barium and strontium oxides in a nickel matrix. Such a matrix is capable of emitting electrons when current flows through the heater inside the cathode cylinder.

At a radius somewhat larger than the outer radius of the cathode is a concentric cylindrical anode. The anode serves two functions: (1) to collect electrons emitted by the cathode and (2) to store and guide microwave energy. The anode comprises a series of quarter-wavelength cavity resonators symmetrically arranged around the cathode.

A radial dc electric field (perpendicular to the cathode) could be applied between cathode and anode. This electric field and the axial magnetic field (parallel and coaxial with the cathode) introduced by pole pieces at either end of the cathode, as described above, provide the required crossed-field configuration.

Preferably, in the underlayer of the perpendicular recording medium of this invention, an easy axis of magnetization is directed in a direction substantially transverse to a traveling direction of the magnetic head. This means that the easy axis of magnetization is directed more toward a direction transverse to the traveling direction of the read-write head than toward the traveling direction. Also, preferably, the underlayer of the perpendicular recording medium has a substantially radial or transverse anisotropy, which means that the domains of the soft magnetic material of the underlayer are directed more toward a direction transverse to the traveling direction of the read-write head than toward the traveling direction.

In accordance with embodiments of this invention, the substrates that may be used in the invention include glass, glass-ceramic, NiP/aluminum, metal alloys, plastic/polymer material, ceramic, glass-polymer, composite materials or other non-magnetic materials. Glass-ceramic materials do not normally exhibit a crystalline surface. Glasses and glass-ceramics generally exhibit high resistance to shocks.

The underlayer, seedlayer, interlayer and magnetic recording layer could be sequentially sputter deposited on the substrate, typically by magnetron sputtering, in an inert gas atmosphere. A carbon overcoat could be typically deposited in argon with nitrogen, hydrogen or ethylene. Conventional lubricant topcoats are typically less than about 20 Å thick.

Amorphous soft underlayers could produce smoother surfaces as compared to polycrystalline underlayers. Therefore, the use of amorphous soft underlayer is one way of reducing the roughness of the magnetic recording media for high-density perpendicular magnetic recording. The amorphous soft underlayers materials include a Cr-doped Fe-alloy-containing underlayer, wherein the Fe-alloy could be CoFeZr, CoFeTa, FeCoZrB and FeCoB.

Another advantage of amorphous materials as soft underlayer materials is the lack of long-range order in the amorphous material. Without a long-range order, amorphous alloys have substantially no magnetocrystalline anisotropy. According to this invention, the use of amorphous soft underlayer is one way of reducing noise caused by ripple domains and surface roughness. The surface roughness of the amorphous soft underlayer is preferably below 0.4 nm, more preferably below 0.3 nm, and most preferably below 0.2 or 0.1 nm.

In an embodiment of the perpendicular media, it would be easier to saturate the sample in radial direction than in circumferential direction. Thus, radial and circumferential directions are called the easy and hard axis, respectively. The underlayers of the disks could also have radial anisotropy. “Anisotropy” could be determined as described in U.S. Pat. No. 6,703,773, which is incorporated herein in entirety by reference.

The Ta-containing seedlayer of the embodiments have a thickness in the range from 3 to 250 Å, preferably in the range of 15 to 200 Å, more preferably in the range of 10 to 100 Å and most preferably in the range of 12 to 40 Å. Also, the Ta-containing seedlayer contains Ta in range of 20-100 atomic percent, preferably in the range of 40-100 atomic percent, more preferably in the range of 60-100 atomic percent and most preferably in the range of 80-100 atomic percent.

The advantageous characteristics attainable by the present invention, particularly, as related to reduction or elimination of DC noise and improved corrosion resistance, are illustrated in the following examples.

### EXAMPLES

All samples described in this disclosure were fabricated with DC magnetron sputtering except carbon films were made with AC magnetron sputtering.

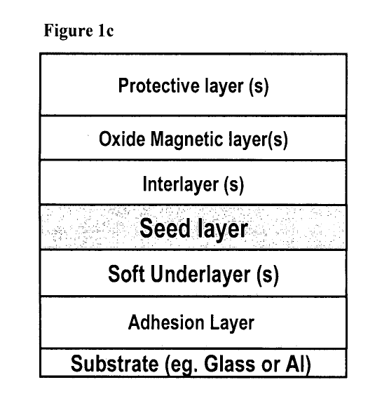

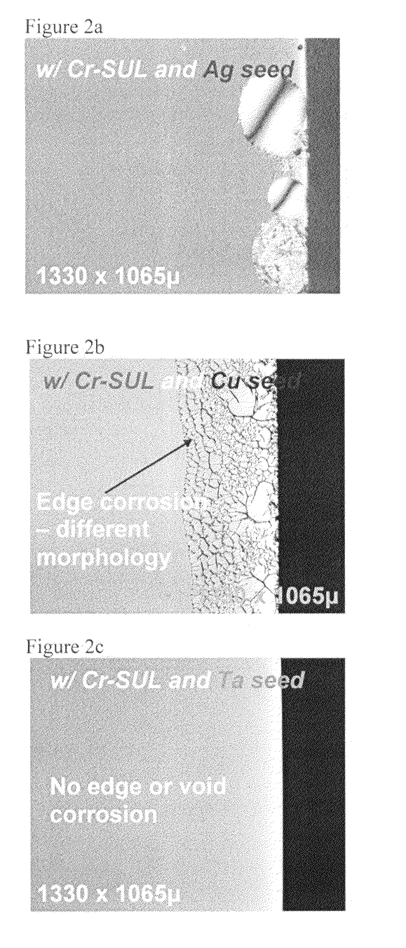

FIGS. 2a through 2c show test result for edge corrosion on perpendicular media having differing transition layer compositions. FIG. 2a illustrates edge corrosion for perpendicular media having an Ag transition layer exposed to 0.5N HCl vapor for twenty-four hours at ambient temperature in an enclosed chamber. After 24-hour exposure, the disks were removed and examined for corrosive growth using an optical microscope. Though the perpendicular media with Ag-transition layer did not show any corrosion growth in the data zone in the studied samples, they had severe edge corrosion as shown in FIG. 2a. In the chamfer area, edge corrosion growth is shown to have caused the top media layers to bubble, and some areas showed collapsed bubbles.

FIG. 2b shows a similar result for perpendicular media containing a Cu-transition layer. The edge of the disk has corrosion penetrating toward the data zone. The corrosion morphology shows a “wrinkle” pattern, which is characteristic of stress relaxation in the top layers when a layer underneath is removed due, for example, to corrosion. Scanning electron microscope and energy dispersive x-ray (SEM/EDX) examination of the corroded area in perpendicular media having both Ag and Cu transition layers revealed that indeed both types of layers had been corroded by the 0.5N HCl vapor.

To overcome the corrosion, several transition metal layers were evaluated, each being resistant to HCL corrosion. Of the candidates tested, perpendicular media made with a tantalum transition layer exhibited excellent corrosion-resistant properties, as shown in FIG. 2c. As can be seen in the micrograph, the data zone and the edge are both free from corrosion after a 24-hour 0.5N HCl vapor exposure at ambient temperature. A superior magnetic performance of recording media having a tantalum transition layer is illustrated in Table 1 below.

TABLE 1
Magnetic recording performance of Ta transition layer based glass media.

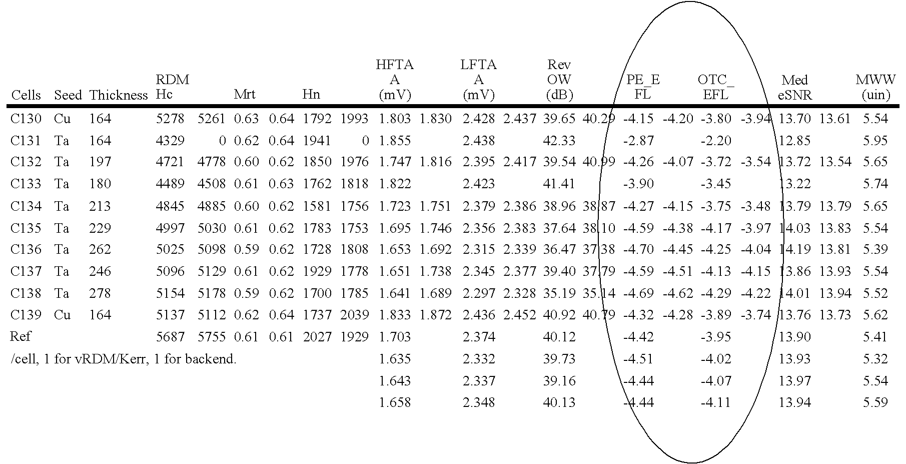

As can be seen from Table 1, perpendicular media having a tantalum transition layer provide about 0.4 decade advantage in PE/OTC EFL (also called BER, i.e., bit error rate or bit error floor) over perpendicular media having a Cu transition layer. An improvement of 0.4 decade is a significant improvement as decade is measured on a logarithmic scale of 10. For example, a one decade improvement means a ten-fold improvement.

It is believed that tantalum, which has a higher melting point, forms smaller, denser nucleation sites for the subsequent interlayer and magnetic storage layers to grow on. Consequently, it provides better BER and SNR performances, as illustrated in Table 2 below.

TABLE 2
Magnetic recording performance of Ta transition layer based aluminum media.

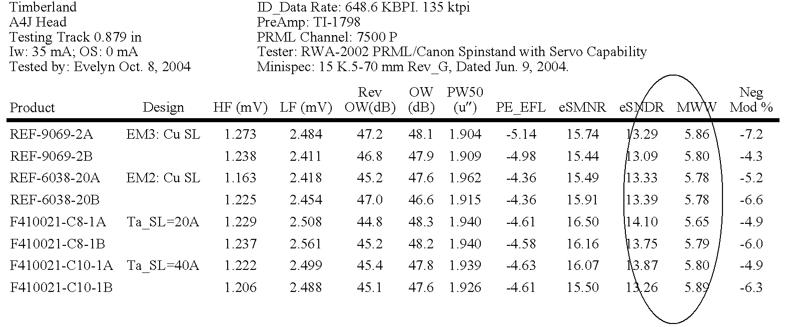

The circled data signifies equalized signal to noise and distortion. That means the signal is stronger than the noise.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations that support any range within the disclosed numerical ranges even though a precise range limitation is not stated verbatim in the specification because this invention can be practiced throughout the disclosed numerical ranges. Finally, the entire disclosure of the patents and publications referred in this application are hereby incorporated herein in entirety by reference.

1. A perpendicular magnetic recording medium comprising a substrate, an underlayer, a Ta-containing seedlayer, a magnetic layer, wherein the underlayer comprises a soft magnetic material and the Ta-containing seedlayer is between the underlayer and the magnetic layer.

2. The recording medium of claim 1, wherein the underlayer comprises Cr.

3. The recording medium of claim 1, wherein the underlayer comprises about 8 to 18 at % Cr.

4. The recording medium of claim 1, wherein the soft magnetic material is substantially amorphous.

5. The recording medium of claim 1, wherein the magnetic layer comprises an oxide-containing magnetic layer.

6. The recording medium of claim 1, further comprising an interlayer between the Ta-containing seedlayer and the magnetic layer.

7. The recording medium of claim 1, wherein the recording medium has substantially no edge corrosion after exposure to 0.5 N HCl vapor environment for 24 hours.

8. The recording medium of claim 1, wherein the Ta-containing seedlayer has a thickness of about 12 to 40 Å.

9. The recording medium of claim 1, wherein the Ta-containing seedlayer contains Ta in the range of 20 to 100 atomic percent.

10. The recording medium of claim 6, wherein the interlayer comprises a Ru-containing material.

11. A method of improving corrosion resistance of a magnetic recording medium comprising forming an underlayer on a substrate, forming a Ta-containing seedlayer on the underlayer and depositing a magnetic perpendicular recording layer on the Ta-containing seedlayer.

12. The method of claim 10, wherein the magnetic perpendicular recording medium has substantially no edge corrosion or void corrosion in the data zone area after 24-hr vapor exposure above 0.5N HCl solution in an enclosed container or after 4-day exposure at 80° C.-80%RH in a controlled humidity chamber.

13. The method of claim 11, wherein the underlayer comprises a Fe-alloy.

14. The method of claim 13, wherein the Fe-alloy is selected from the group consisting of a FeCoB alloy, a CoFeZr alloy, a CoFeTa alloy, and a FeCoZrB alloy.

15. The method of claim 11, wherein the underlayer comprises about 9-17 at % Cr.

16. A method of manufacturing a magnetic recording medium, comprising depositing an underlayer on a substrate, depositing a Ta-containing seedlayer on the underlayer and depositing a magnetic perpendicular recording layer on the Ta-containing seedlayer.

17. The method of claim 16, wherein the underlayer comprises a Fe-alloy.

18. The method of claim 16, wherein the Ta-containing seedlayer comprises Ta in the range of 20 to 100 atomic percent and the thickness of the Ta-containing seedlayer is in the range of 12 to 40 Å.

19. The method of claim 11, wherein the underlayer has a polarization resistance of at least 1×10⁵ ohm-cm².

20. The method of claim 19, wherein the polarization resistance is at least 1×10⁶ ohm-cm².
